(19) United States
(12) Patent Application Publication
(10) Pub. No.: US 2006/0125715 A1
(43) Pub. Date: Jun. 15, 2006

(54) Liquid crystal display device having OCB mode and method of driving the same

(76) Inventor: Kyung-Ho Choi, Ulsan-si (KR)

Correspondence Address: CHRISTIE, PARKER & HALE, LLP, PO BOX 7068, PASADENA, CA, 91109-7068, US

(21) Appl. No.: 11/294,844

(22) Filed: Dec. 5, 2005

(30) Foreign Application Priority Data
Dec. 10, 2004 (KR) 2004-104487

(51) Int. Cl. G09G 1/08

(52) U.S. Cl. 345/14

(57) ABSTRACT

A liquid crystal display device (LCD) which applies a high voltage for carrying out a bend transition of an optically compensated birefringence (OCB) liquid crystal as a reset voltage to a common electrode of the OCB liquid crystal in the LCD having an OCB mode, and a method of driving the same are provided. In the OCB mode LCD, a voltage of a DC-DC converter is applied to a common electrode to reset the OCB liquid crystal at an initial stage of every frame or before applying data to each pixel. In addition, when one frame is divided into red, green and blue fields, and sequentially driven, a voltage of the DC-DC converter is applied to the common electrode to reset the OCB liquid crystal before each field begins. The DC-DC converter applies a voltage of 15V to 30V to the common electrode. An optical transmittance of the liquid crystal at the time of reset becomes zero (black state). Accordingly, a blurring effect can be removed while a reset time can be decreased, thereby increasing the brightness.

### CROSS-REFERENCE TO RELATED APPLICATIONS

This application claims priority to and the benefit of Korean Patent Application No. 10-2004-0104487, filed Dec. 10, 2004, the contents of which are hereby incorporated herein by reference in their entirety.

### BACKGROUND OF THE INVENTION

1. Field of the Invention

The present invention relates to a liquid crystal display device (LCD) and a method of driving the same, and more particularly, to an optically compensated bend or birefringence (OCB) mode LCD and a method of driving the same, which applies a high voltage for carrying out a bend transition of an OCB liquid crystal as a reset voltage to a common electrode of the OCB liquid crystal.

2. Description of the Related Art

In recent years, personal computers, televisions and the like have become lightweight and small in size, which requires lightweight and small-sized displays. Consequently, flat panel displays such as liquid crystal display devices (LCD) have become the focus of development, instead of cathode ray tubes (CRT).

In an LCD, an electric field is applied to a liquid crystal injected between two substrates and having an anisotropic dielectric constant. The intensity of the electric field is adjusted to control the amount of light from an external light source (backlight) transmitted through the substrate, thereby obtaining a desired image signal.

However, an LCD has a different brightness and color according to the angle at which it is observed, and thus has a narrow viewing angle. Various ways of resolving this viewing angle problem have been suggested. For example, in order to improve the viewing angle range of an LCD, a technique for arranging a prism sheet on a light guide plate to improve the straightness of light emitted from a backlight, which improves brightness in a vertical direction by more than 30%, has been put into practice. A technique for providing a negative compensation film to improve the viewing angle range is also being employed.

In addition, an In-Plane-Switching mode has been developed to achieve a wide viewing angle of 160° in up, down, right and left directions, which is almost the same viewing angle range as a CRT. However, this method has a low aperture ratio and thus needs further improvement.

Moreover, in order to improve the viewing angle range, thin film transistor (TFT) driving techniques including an optically compensated birefringence or bend (OCB) method, a polymer dispersed liquid crystal (PDLC) method, a deformed helix ferroelectric (DHF) method, and so on, have been suggested.

In particular, the OCB method has been the focus of considerable research and development efforts, because it has a rapid response speed and a wide viewing angle, so that it provides advantages in realizing a moving picture.

FIG. 1 is a view illustrating states of a liquid crystal to describe operation of a conventional OCB method.

Referring to FIG. 1, an initial alignment state of the OCB liquid crystal arranged between an upper plate electrode and a lower plate electrode is homogeneous, and when a predetermined voltage is applied across the upper and lower plate electrodes, the state of the liquid crystal changes via a transient splay and an asymmetric splay into a bend state. This controlled change allows the liquid crystal to be used in an OCB mode.

As shown in FIG. 1, an OCB liquid crystal cell has a tilt angle of about 10° to 20° and a thickness of about 4 μm to 7 μm. An alignment layer is rubbed in the same direction. Liquid crystal molecules in a central portion of a liquid crystal layer are symmetrically arranged in right and left directions, and thus a tilt angle is 0° at less than a predetermined voltage and 90° at more than the predetermined voltage. A high voltage is initially applied, so that the tilt angle of the liquid crystal molecules in the central portion of the liquid crystal layer becomes 90°, and then the applied voltage is varied to change the tilt angle of liquid crystal molecules except the liquid crystal molecules in the central portion of the liquid crystal layer, thereby modulating the polarization of light transmitted through the liquid crystal layer. It takes several seconds to arrange the tilt angle of the liquid crystal molecules in the central portion from 0° to 90°, which has no back-flow and has a bending transformation with a large elastic coefficient, so that a response time is as fast as 10 μm.

A predetermined time, that is, a bend transition time is required to obtain a bend alignment for the OCB mode, and a high voltage should be applied to both ends of the liquid crystal in order to decrease such a transition time. In general, such a high voltage can be applied to a common electrode using a direct current to direct current (DC-DC) converter as an external power supply, such that the bend alignment can be implemented at a fast speed.

LCDs are commonly used in portable flat panel displays. In these displays, a thin film transistor liquid crystal display (TFT-LCD) is often employed which uses TFTs as switching devices.

Each pixel can be connected to a capacitor having a liquid crystal as a dielectric material. In the TFT-LCD, for example, each pixel can be connected to a liquid crystal capacitor. An example circuit including such a pixel in an LCD is shown in FIG. 2.

FIG. 2 is a diagram illustrating a representative pixel circuit among n×m pixels of a conventional LCD.

As shown in FIG. 2, each pixel of the LCD includes a TFT 10 in which a source electrode and a gate electrode are respectively connected to a data line Dm and a scan line Sn. A liquid crystal capacitor C_{LC} is connected between a drain electrode of the TFT and a common electrode ‘com.’ A storage capacitor Cst is connected to the drain electrode of the TFT.

Referring to FIG. 2, when a scan signal is applied to the scan line Sn to turn on the TFT 10, a data voltage Vd supplied to the data line is applied to each pixel electrode (not shown) via the TFT 10. As a result, an electric field corresponding to a difference between the common voltage Vcom and a pixel voltage Vp applied to the pixel electrode is applied to the liquid crystal (shown as an equivalent liquid crystal capacitor C_{LC} in FIG. 2), so that light is transmitted with a transmittance corresponding to the intensity of the electric field. In this case, the pixel voltage Vp should be maintained for one frame or one field, and the storage capacitor Cst shown in FIG. 2 is used as an auxiliary element to keep the pixel voltage applied to the pixel electrode for one frame or one field.

In general, LCDs can be categorized into a color filter method and a field sequential method based on a manner of displaying a color image.

In the color-filter type LCD, a color filter layer composed of three primary colors of red (R), green (G), and blue (B) colors is formed on one substrate out of two substrates, and the amount of light transmitted through the color filter layer is adjusted to display a desired color. In the color-filter type LCD, the amount of light transmitted through the R, G, and B color filters is adjusted by controlling the amount of light transmitted through the liquid crystal after it is irradiated from a single light source (e.g., a backlight), and R, G, and B colors are then combined to display a desired color.

In an LCD displaying a color using R, G, and B color filter layers and a single light source, a pixel unit corresponding to each region of the R, G, and B colors is required, so that three times as many pixels are required for displaying colors than for displaying black and white. Accordingly, a technique for fabricating very small pixel units in an LCD panel is required in order to obtain color images having a high resolution. In addition, it is burdensome to form a separate color filter layer on an LCD substrate. The optical transmittance of the color filter itself is low.

The field-sequential LCD allows R, G, and B colors to be sequentially and periodically turned on, and a color signal corresponding to each pixel is applied in synchronization with the turn-on period to thereby obtain a full color image. That is, according to the field-sequential LCD, one pixel is not divided into R, G, and B unit pixels, and the light of the three primary colors is provided from the R, G, and B backlights to one pixel so that they are sequentially displayed in a time division manner, thereby displaying a color image using an afterimage effect of vision.

As such, the field sequential drive method can be further classified into an analog drive method and a digital drive method.

According to the analog drive method, a plurality of gray scale voltages corresponding to the number of gray scale values to be displayed are set, and one gray scale voltage corresponding to a gray scale value is selected to drive the LCD panel, thereby displaying the gray scale value with the amount of transmitted light corresponding to the applied gray scale voltage.

FIG. 3 is a chart illustrating a drive voltage and an optical transmittance in accordance with an LCD of a conventional analog driving type.

Referring to FIG. 3, a drive voltage means a voltage applied to the liquid crystal. An optical transmittance means a transmittance rate relative to an amount of light that is applied to the liquid crystal. That is, the optical transmittance is based on a tilt degree of the liquid crystal that determines the amount of light to be transmitted through the liquid crystal.

Referring to FIG. 3, a drive voltage of V11 level is applied to the liquid crystal in an R field Tr for displaying an R color so that light corresponding to the drive voltage of V11 level is transmitted through the liquid crystal. A drive voltage of V12 level is applied to the liquid crystal in a G field Tg for displaying a G color so that light corresponding to the drive voltage of V12 level is transmitted through the liquid crystal. A drive voltage of V13 level is applied to the liquid crystal in a B field Tb for displaying a B color so that light corresponding to the drive voltage of V13 level is transmitted through the liquid crystal. Combination of the R, G, and B light transmitted in the respective Tr, Tg, and Tb fields displays a desired color image.

Meanwhile, the digital drive method provides a constant drive voltage to be applied to the liquid crystal, and controls a voltage-applying time to display gray scale images. According to the digital drive method, the drive voltage is constantly kept and a voltage-applying state and a non-voltage applying state are controlled by a timing method to adjust the total amount of light transmitted through the liquid crystal.

FIG. 4 is a chart illustrating a drive voltage and an optical transmittance in accordance with a liquid crystal display of a conventional digital driving type, which shows a waveform of a drive voltage based on drive data of predetermined bits, and an optical transmittance of the liquid crystal therefrom.

Referring to FIG. 4, gray scale waveform data are provided as, for example, a digital signal of seven bits, and a gray scale waveform in response to the data of seven bits is applied to the liquid crystal. An optical transmittance of the liquid crystal is determined in response to the applied gray scale waveform to thereby display gray scale images.

According to the conventional color filter type LCD, a response of the liquid crystal to gray scale data being sequentially applied in a previous frame affects a response of the liquid crystal to gray scale data in a current frame.

In addition, according to a conventional field sequential drive method, the actual display of the gray scale value (e.g. an R gray scale vale) to be displayed is affected by the gray scale (e.g. a B gray scale value) that was displayed right before it, so that it is unlikely that correct gray scale values will be displayed. That is, a pixel voltage Vp actually supplied to the liquid crystal is determined not only by a gray scale voltage (or gray scale waveform) that is being applied in the current field (e.g. R field) but also a gray scale voltage (or gray scale waveform) applied in the previous field (e.g. B field).

This causes a blurring effect and a blurred image by mixing a gray scale value of the previous frame or the previous field with a gray scale value of the current frame or the current field in the case of a fast moving picture.

As such, to cope with the conventional problem that the liquid crystal response is affected depending on the gray scale data displayed in the previous field or the previous frame, a drive method for the LCD using a reset pulse has been proposed.

FIG. 5 is a view illustrating a driving method of a conventional LCD using a reset pulse.

Referring to FIG. 5, a predetermined voltage (reset voltage) independent of the input gray scale data and higher than a maximum value of the gray scale data is applied for a predetermined time (t31-t36) at the end of each of the gray scale data input periods T31-T36. By applying such a reset voltage, liquid crystal states at the end of each of the gray scale data input periods T31-T36 are initialized to the same state, (e.g. a black state of not transmitting light, i.e., a state having an optical transmittance of zero).

Accordingly, the liquid crystal begins in the same state regardless of the gray scale value that was previously displayed when the liquid crystal is driven by the applied voltage in response to gray scale data in each of the periods T31-T36, so that the gray scale value that was previously displayed does not affect the subsequent display of the gray scale.

According to the conventional reset method, a blurring effect can be removed because the liquid crystal states have a consistent starting state, i.e., the black state by means of the reset voltage before gray scale data are applied. However, a maximum reset voltage is 5V to 7V, which requires a long time to reset the liquid crystal, and a time taken for the light source to be transmitted decreases by the amount of time taken by the reset. As a result, brightness decreases compared to a drive manner of not applying the reset voltage.

### SUMMARY OF THE INVENTION

The present invention provides an OCB mode LCD with a decreased blurring effect and an enhanced brightness by using an external high voltage as a liquid crystal reset voltage and applying it to a common electrode at an initial stage of every frame or whenever gray scale data is applied to thereby reset the liquid crystal in a short time, and a method of driving this process.

An LCD includes: a liquid crystal display panel having a plurality of pixels, each pixel being positioned at an intersection between a plurality of scan lines and a plurality of data lines and including a liquid crystal capacitor composed of a common electrode, a pixel electrode, and an optically compensated birefringence or bend (OCB) liquid crystal; a scan driver for applying a scan signal to the plurality of scan lines; a source driver for applying gray scale data, including in one embodiment red, green, blue gray scale data, to the plurality of data lines; a DC-DC converter outputting a DC voltage for carrying out a bend transition on the OCB liquid crystal; a switch selecting the output voltage of the DC-DC converter and a common voltage and transferring the voltages to the common electrode; a light source controller controlling a backlight for emitting light to the liquid crystal display panel, including in one embodiment red, green, and blue light emitting diodes; and a timing controller controlling operations of the scan driver, the source driver, the switch, and the light source controller, and in one embodiment wherein the switch applies the output voltage of the DC-DC converter to the common electrode before the start of each frame to reset the OCB liquid crystal or to reset the OCB liquid crystal before the gray scale data are applied to the plurality of pixels. In another embodiment, one frame is divided into red, green, and blue fields, and the switch applies the output voltage of the DC-DC converter to the common electrode before the start of each field to reset the OCB liquid crystal.

A method of driving an LCD that includes a plurality of pixels having an OCB liquid crystal positioned between a common electrode to which a common voltage is applied and a pixel electrode to which gray scale data are applied, or in another embodiment a pixel electrode to which red, green, and blue gray scale data are sequentially applied, a DC-DC converter outputting a voltage for carrying out a bend transition on the OCB liquid crystal at a fast speed, and a backlight outputting light to the plurality of pixels, or in another embodiment, a backlight having red, green, and blue light sequentially transmitted to each of the pixels. The method includes: (a) applying a voltage to the OCB liquid crystal from the DC-DC converter to carry out the bend transition on the OCB liquid crystal at an initial start of the LCD; (b) applying the gray scale data of a frame to the pixel electrode in the frame; (c) applying a voltage to the common electrode from the DC-DC converter to reset the OCB liquid crystal after the step (b); (d) applying the gray scale data of a subsequent frame (e.g., the immediate following frame or second frame) to the pixel electrode in the subsequent frame; and (e) repeating the steps (b) to (d).

In another embodiment, the method includes: (a) applying a voltage to the OCB liquid crystal from the DC-DC converter to carry out the bend transition on the OCB liquid crystal at an initial start of the LCD; (b) dividing one frame into red, green, and blue fields, and applying the red gray scale data to the pixel electrode in the red field; (c) applying a voltage to the common electrode from the DC-DC converter to reset the OCB liquid crystal after the step (b); (d) applying the green gray scale data to the pixel electrode in the green field; (e) applying a voltage to the common electrode from the DC-DC converter to reset the OCB liquid crystal after the step (d); (f) applying the blue gray scale data to the pixel electrode in the blue field; (g) applying a voltage to the common electrode from the DC-DC converter to reset the OCB liquid crystal after the step (f); and (h) repeating the steps (b) to (g).

In a further embodiment, the method includes: (a) applying a voltage to the OCB liquid crystal from the DC-DC converter to carry out a bend transition on the OCB liquid crystal at an initial start of the LCD; (b) applying (n−1)th gray scale data to a pixel electrode of an (n−1)th pixel among the plurality of pixels; (c) applying a voltage to the common electrode from the DC-DC converter to reset the OCB liquid crystal after the step (b); (d) applying nth gray scale data to a pixel electrode of an nth pixel; (e) applying a voltage to the common electrode from the DC-DC converter to reset the OCB liquid crystal after the step (d); and (f) repeating the steps (b) to (e).

### BRIEF DESCRIPTION OF THE DRAWINGS

The accompanying drawings, together with the specification, illustrate certain exemplary embodiments of the present invention and serve to explain the principles of the present invention.

FIG. 1 is a diagram illustrating liquid crystal states for explaining an operation of a conventional OCB mode.

FIG. 2 is a diagram illustrating a representative pixel circuit of n×m pixels of a conventional LCD.

FIG. 3 is a chart illustrating a drive voltage and an optical transmittance in accordance with a liquid crystal display of a conventional analog driving type.

FIG. 4 is a chart illustrating a drive voltage and an optical transmittance in accordance with a liquid crystal display of a conventional digital driving type.

FIG. 5 is a chart illustrating a driving method of a conventional LCD using a reset pulse.

FIG. 6 is a block diagram of an OCB mode LCD in accordance with an embodiment of the present invention.

FIG. 7 is a timing diagram illustrating a method of driving an OCB mode LCD in accordance with a first embodiment of the present invention.

FIG. 8 is a timing diagram illustrating a method of driving a field-sequential LCD having an OCB mode in accordance with a second embodiment of the present invention.

FIG. 9 is a timing diagram illustrating a method of driving an OCB mode LCD in accordance with a third embodiment of the present invention.

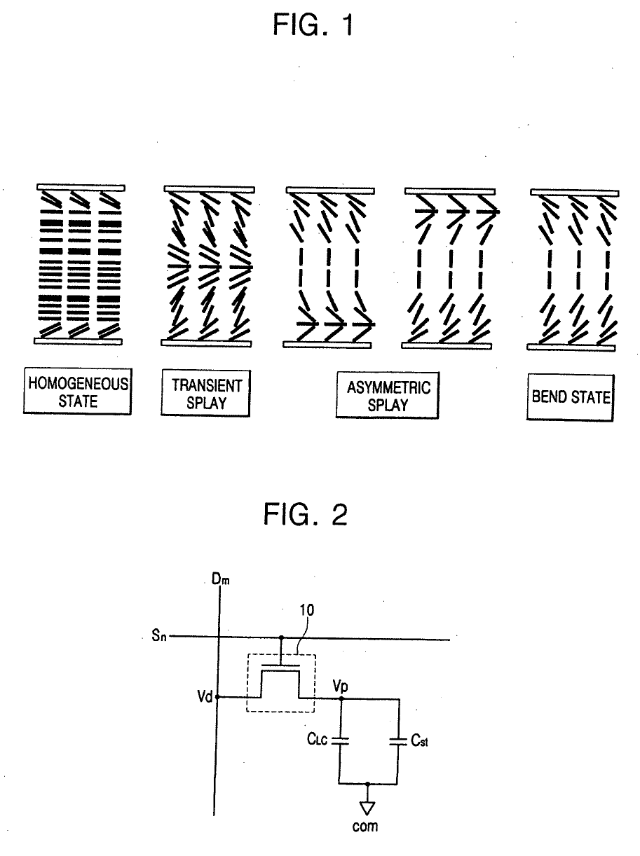

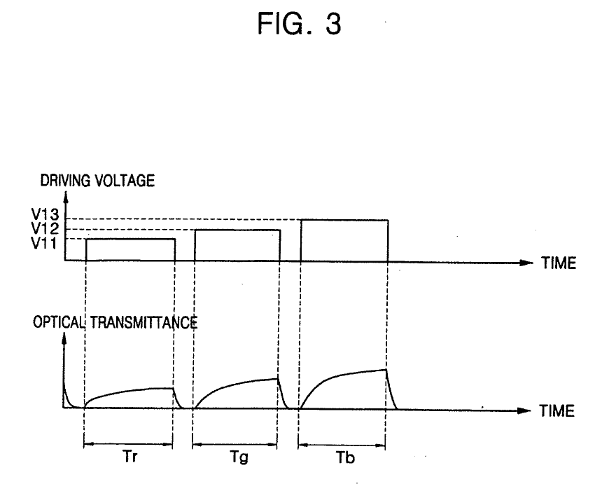

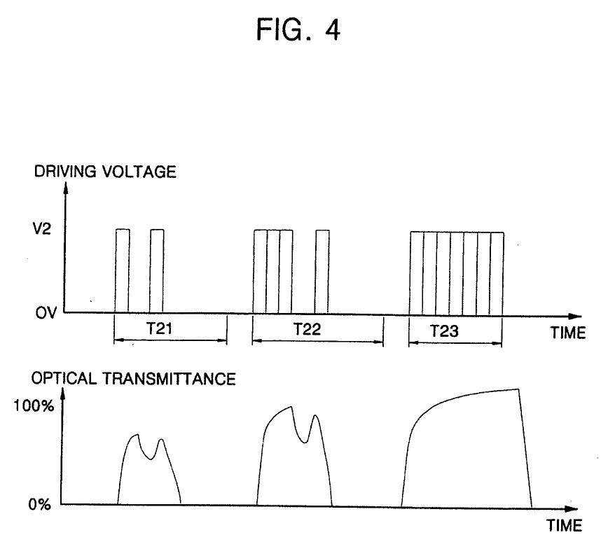

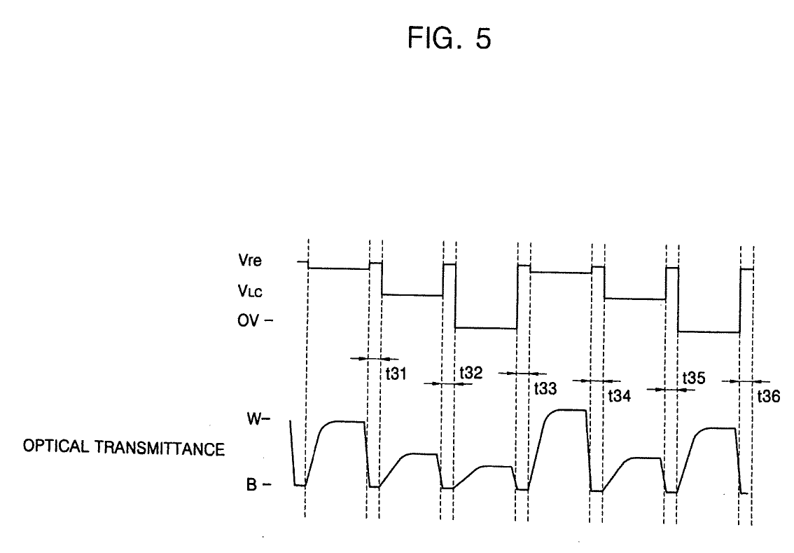

### DETAILED DESCRIPTION

The present invention will now be described more fully hereinafter with reference to the accompanying drawings. A term “reset” to be described refers to a voltage (or waveform) is applied in order to make a black state (a state having an optical transmittance of zero) in which light of a backlight is not transmitted through an OCB liquid crystal material present in an LCD. A term “gray scale data” refers to a set of values indicating voltage levels different from each other for controlling the transmittance of a pixel. A term “optical transmittance” refers to the amount of light transmitted through liquid crystal relative to the amount of applied light when it is assumed that light is constantly applied to the liquid crystal. A term “amount of transmitted light” refers to the amount of light, which is transmitted through the liquid crystal after the light has been applied to the liquid crystal.

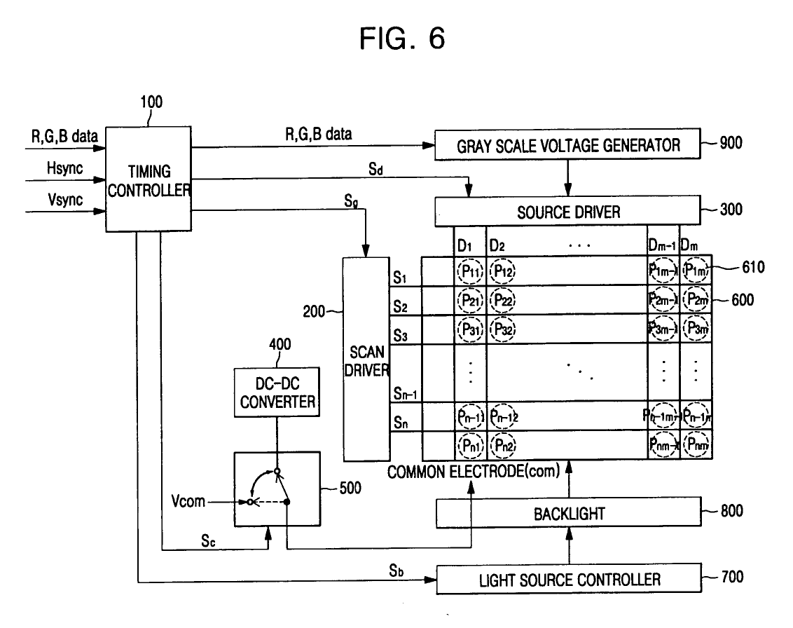

FIG. 6 is a block diagram of an OCB mode LCD in accordance with an embodiment of the present invention.

Referring to FIG. 6, the OCB mode LCD according to the embodiment of the present invention includes a timing controller 100, a scan driver 200, a source driver 300, a DC-DC converter 400, a switch 500, an LCD panel 600, a light source controller 700, a backlight 800, and a gray scale voltage generator 900.

The LCD panel 600 has a plurality of pixels 610 formed at each intersection of a plurality of scan lines S1 to Sn and a plurality of data lines D1 to Dm. The plurality of pixels 610 have been described with reference to FIG. 2.

The scan driver 200 applies gate voltages via the plurality of scan lines S1 to Sn, and the source driver 300 applies data voltages via the plurality of data lines D1 to Dm to corresponding pixels to drive the LCD panel 600.

The gray scale voltage generator 900 generates a gray scale voltage having a magnitude corresponding to each of the gray scale values of the R, G and B data and supplies it to the data driver 300.

The DC-DC converter 400 outputs a predetermined bias voltage to the switch 500, and the output bias voltage is applied from the switch 500 to the common electrode of the pixel 610 at every initial start of the liquid crystal and initial stage of every frame, or initial stage of every field, or whenever a new gray scale value or data are applied (in a case of color filter driving). The bias voltage output from the DC-DC converter 400 has a value of 15V to 30V to perform a fast bend transition for the OCB liquid crystal.

By means of the switch 500, the bias voltage of the DC-DC converter 400 is applied to the common electrode of the pixel 610 at an initial start of the OCB liquid crystal and at an initial stage of every frame, or at an initial stage of every field (in a case of the field-sequential drive), or whenever new gray scale values or data are applied (in case of the color-filter drive) depending on a switching control signal Sc applied from the timing controller 100.

The timing controller 100 receives gray scale data signals of R, G, and B data, a horizontal synchronization signal Hsync, and a vertical synchronization signal Vsync from an external source or a graphic controller (not shown), supplies necessary control signals Sg, Sd, Sc, and Sb to each of the scan driver 200, the source driver 300, the switch 500, and the light source controller 700, and supplies gray scale data R, G, B data to the gray scale voltage generator 900. The timing controller 100 sends the control signal Sc to the switch 500 to apply a high voltage for performing a bend transition on the OCB liquid crystal at a fast speed at an initial start of the LCD, and then applies the control signal Sc to the switch 500 so as to apply the reset voltage Vre of the DC-DC converter 400 at an initial stage of every frame or every field (in a case of the field sequential drive method) or whenever new gray scale values or data are applied (in a case of the color filter drive method) and so as to apply the common voltage Vcom in the rest periods. In addition, the timing controller 100 provides the light source control signal Sb for driving the backlight 600 to the light source controller 500 after the bend transition of the OCB liquid crystal.

The light source controller 500 applies a predetermined voltage for driving the backlight 600 disposed at a rear surface of the LCD panel 400 in response to the backlight control signal Sb applied from the timing controller 100. The backlight 600 may be composed of a red light emitting diode (RLED), a green LED (GLED), and a blue LED (BLED) which sequentially output red, green, and blue light in the case of the field-sequential drive method, and may be composed of a cold cathode fluorescence lamp (CCFL) or a white LED which outputs white light in the case of the color filter drive method. In the case of the LCD using the color filter drive method, red, green, and blue color filters are positioned on the common electrode per unit pixel.

As such, the OCB mode LCD according to the embodiment of the present invention uses a high voltage applied to the common electrode of the LCD panel to apply a high reset voltage for a short time at an initial stage of every frame or every field (in the case of filed sequential drive method) or whenever gray scale data is applied (in the case of color filter drive method) to perform a bend transition at a fast speed at an initial start of the OCB liquid crystal, thereby reducing the blurring effect on images caused by the mixing of the settings of the previous frame, the previous field, or the previous gray scale data with the subsequent settings, and alleviating the decreased brightness caused by the insertion of black data because the reset voltage is applied for a short time. In other words, the time that black is displayed for resetting the pixels is shortened thereby resulting in a brighter display.

Hereinafter, a method of driving an OCB mode LCD in accordance with embodiments of the present invention will be described in detail.

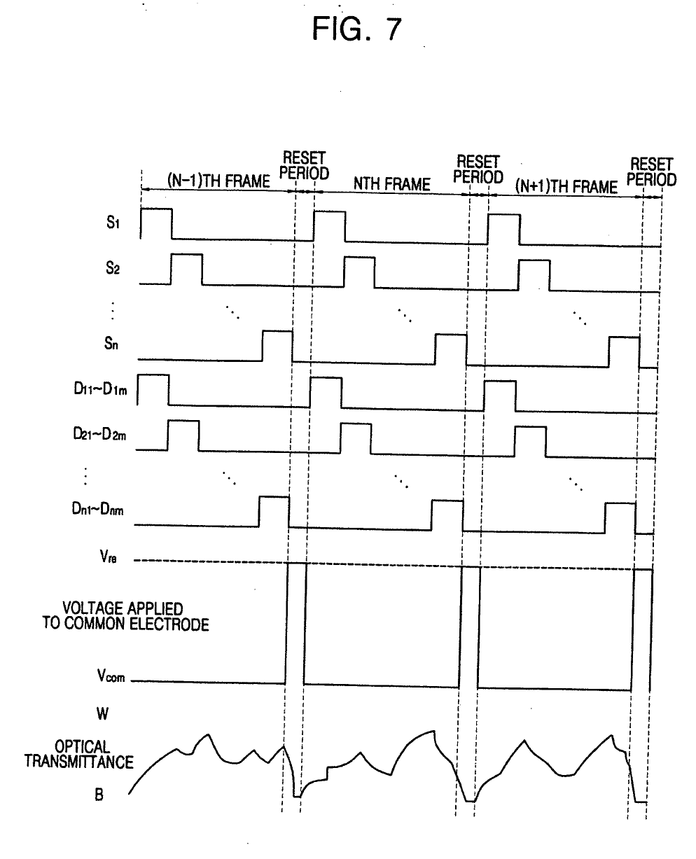

FIG. 7 is a timing diagram illustrating a method of driving an OCB mode LCD in accordance with a first embodiment of the present invention.

Referring to FIG. 7, an (n−1)^{th} frame, an n^{th} frame, and an (n+1)^{th} frame among a plurality of frames are representatively shown. In this case, a term “frame” means that an image is represented on the LCD panel 600 by sequentially applying scan signals from a first scan line S1 to an n^{th} scan line Sn from the scan driver 200, and sequentially applying data signals D1-Dm from a first data line D1 to an m^{th} data line Dm from the source driver 300 in synchronization with the scan signals. In the case of a field sequential LCD, the backlight 800 sequentially emits light via a red LED, a green LED, and a blue LED. In addition, in the case of a color filter type LCD, the backlight 800 emits white light (e.g. WLED or CCFL), and has red, green, and blue color filters per unit pixel so that colors can be implemented via respective color filters.

Referring to FIG. 7 and the LCD shown in FIG. 6, in the method of driving the LCD according to the first embodiment of the present invention, when a scan signal is applied to a first scan line S1 from the scan driver 200 in the (n−1)^{th} frame, pixels P11-P1m connected to the first scan line S1 are selected. Data signals D11-D1m are provided from the source driver 300 to pixel electrodes as lower electrodes of liquid crystal capacitors C_{LC} of the pixels P11-P1m, which are connected to the first scan line S1. A common electrode Com, which is an upper electrode of the liquid crystal capacitor C_{LC} is applied with a common voltage Vcom as a reference voltage while the first scan line S1 of the (n−1)^{th} frame is driven. During this frame, the backlight 800 emits light to be transmitted via the OCB liquid crystal, which has a transmittance corresponding to the data signals D11-D1m while the first scan line S1 of the (n−1)^{th} frame is driven.

Next, when a scan signal is applied to a second scan line S2 from the scan driver 200 in the (n−1)^{th} frame, pixels P21-P2m, which are connected to the second scan line S2 are selected. Data signals D21-D2m are provided from the source driver 300 to pixel electrodes as lower electrodes of liquid crystal capacitors C_{LC} of the pixels P21-P2m, which are connected to the second scan line S2. The common electrode Com is an upper electrode of the liquid crystal capacitor C_{LC} and is applied with a common voltage Vcom as a reference voltage while the second scan line S2 of the (n−1)^{th} frame is driven. During this frame, the backlight 800 emits light to be transmitted via the OCB liquid crystal having a transmittance corresponding to the data signals D21-D2m while the second scan line S2 of the (n−1)^{th} frame is driven.

The third, fourth, and remaining scan lines (S3, S4-Sn) are sequentially scanned in the (n−1)^{th} frame in the above-described order, and when a scan signal Sn is finally applied to an n^{th} scan line Sn in the (n−1)^{th} frame, pixels Pn1-Pnm, which are connected to the n^{th} scan line Sn are selected. Data signals Dn1-Dnm are provided from the source driver 300 to pixel electrodes as lower electrodes of liquid crystal capacitors C_{LC} of the pixels Pn1-Pnm, which are connected to the n^{th} scan line Sn. The common electrode Com is an upper electrode of the liquid crystal capacitor C_{LC} and is applied with a common voltage Vcom as a reference voltage while the n^{th} scan line Sn of the (n−1)^{th} frame is driven. During this frame, the backlight 800 emits light to be transmitted via the OCB liquid crystal having a transmittance corresponding to the data signals Dn1-Dnm while the n^{th} scan line Sn of the (n−1)^{th} frame is driven.

Meanwhile, before the n^{th} frame is displayed after the (n−1)^{th} frame is displayed, the timing controller 100 controls the switch 500 by applying a switching control signal Sc to the switch 500 so as to apply a high voltage Vre output from the DC-DC converter 400 to the common electrode Com of the liquid crystal capacitor C_{LC} to thereby rapidly reset the liquid crystal. In this case, an optical transmittance of the OCB liquid crystal becomes zero (black state).

Subsequently, the n^{th} frame and the (n+1)^{th} frame are sequentially executed. The n^{th} frame and the (n+1)^{th} frame carry out the same operation as that of the (n−1)^{th} frame. In addition, at an initial stage of every frame start, the timing controller 100 controls the switch 500 by applying a switching control signal Sc to the switch 500 so as to apply a high voltage Vre output from the DC-DC converter 400 to the common electrode Com of the liquid crystal capacitor C_{LC} to thereby rapidly reset the OCB liquid crystal for all pixels P11-Pnm. Hereinafter, a method of driving the n^{th} frame and the (n+1)^{th} frame can be readily understood by reading the description on the (n−1)^{th} frame by those skilled in the art, so that its description will be omitted.

The color filter type LCD according to the first embodiment of the present invention applies a high voltage Vre output from the DC-DC converter 400 to the common electrode at an initial stage of every frame to simultaneously reset the OCB liquid crystal of all pixels, P11-Pnm, at a fast speed, thereby reducing a blurring effect that causes a screen to become blurred due to the current frame being affected by the pixel data of the previous frame, and preventing the brightness from deteriorating due to the insertion of black data because the high voltage used to perform a bend transition on the liquid crystal in the OCB mode is used as a reset voltage Vre to shorten the reset time.

It is apparent that the method of driving the OCB mode LCD according to the first embodiment of the present invention may be applied to both of the color filter method and the field sequential method.

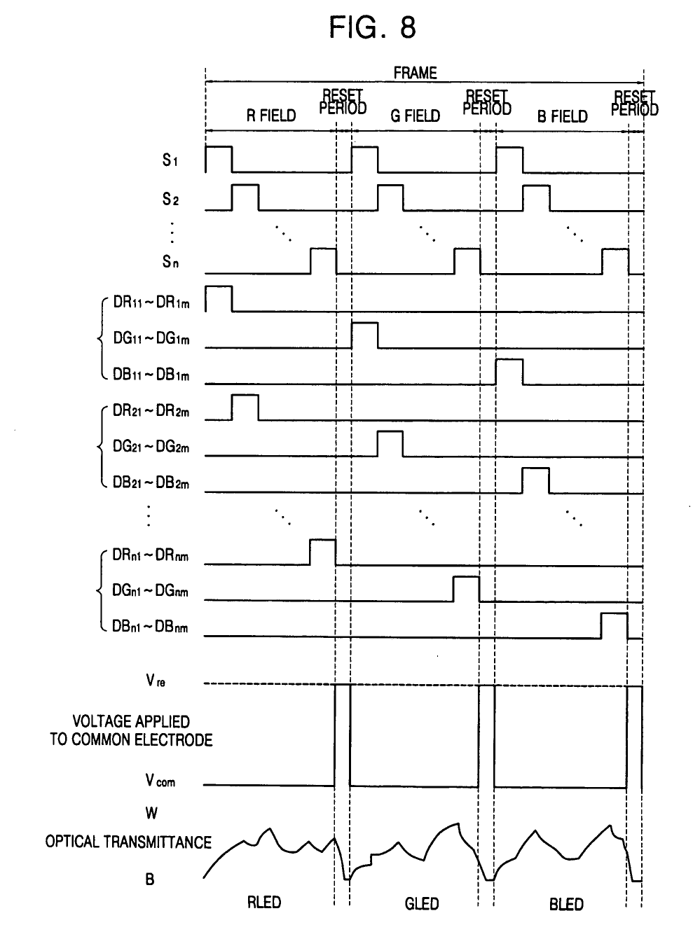

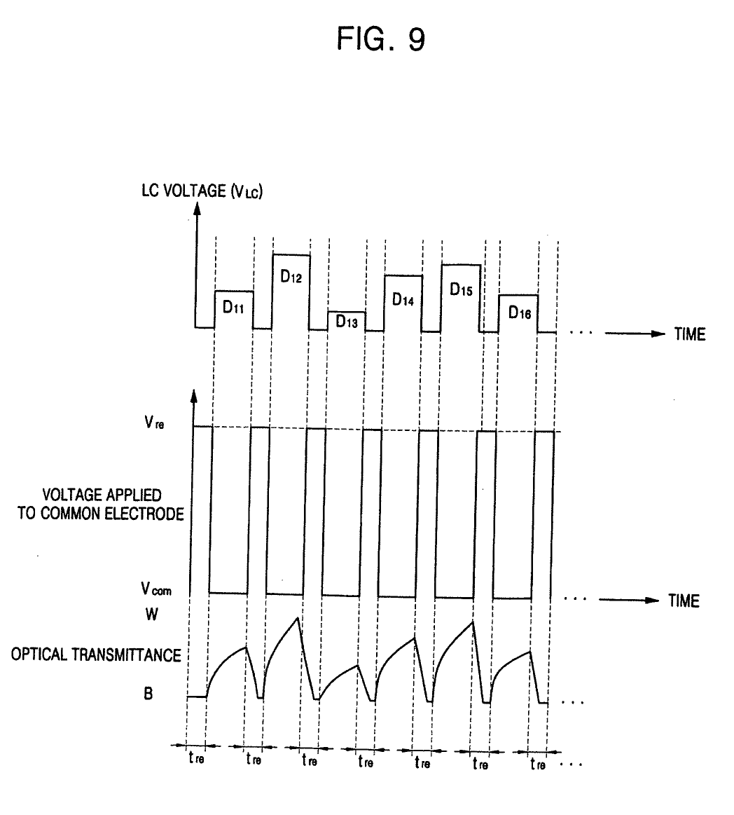

FIG. 8 is a timing diagram illustrating a method of driving a field-sequential LCD having an OCB mode in accordance with a second embodiment of the present invention.

Referring to FIG. 8 and the LCD shown in FIG. 6, in the field-sequential LCD, one frame is divided into red (R), green (G), and blue (B) fields. Each of the plurality of pixels 610 arranged in the LCD panel 600 in a matrix form sequentially displays three primary lights of R, G, and B colors output from the R, G, and B backlights in a time-division manner, thereby displaying a color image using an afterimage effect on vision.

When a first scan signal S1(R) is applied to a first scan line S1 from the scan driver 200 in the R field of the frame, pixels P11-P1m, which are connected to the first scan line S1 are selected. R data signals DR11-DR1m over data lines D1-Dm are provided from the source driver 300 to pixel electrodes as lower electrodes of liquid crystal capacitors C_{LC} of the pixels P11-P1m, which are connected to the first scan line S1. A common electrode Com is an upper electrode of the liquid crystal capacitor C_{LC} in the R field and is applied with a common voltage Vcom as a reference voltage. During this field of the frame, the red backlight RLED emits a light source in the R field so that the OCB liquid crystal allows the red light source to be transmitted with an optical transmittance corresponding to the data signals DR11-DR1m.

Before the R field in the frame transitions to the G field, the timing controller 100 applies a high voltage output from the DC-DC converter 400 to the common electrode Com of the liquid crystal capacitors C_{LC} by applying a switching control signal Sc to the switch 500, thereby rapidly resetting the OCB liquid crystal. Due to the resetting, the optical transmittance of the liquid crystal becomes zero (black state).

Subsequently, in the G field of the frame, when a second scan signal S1(G) is applied to a first scan line S1 from the scan driver 200, pixels P11-P1m, which are connected to the first scan line S1, are selected. G data signals DG11-DG1m over data lines D1-Dm are provided from the source driver 300 to pixel electrodes as lower electrodes of liquid crystal capacitors C_{LC} of the pixels P11-P1m, which are connected to the first scan line S1. The common electrode Com is an upper electrode of the liquid crystal capacitor C_{LC} in the G field and is applied with a common voltage Vcom as a reference voltage. During this field of frame one, the green backlight GLED emits a light source in the G field so that the OCB liquid crystal allows the green light source to be transmitted with an optical transmittance corresponding to the data signals DG11-DG1m.

Before the G field in the frame transitions to the B field, the timing controller 100 applies a high voltage output from the DC-DC converter 400 to the common electrode Com of the liquid crystal capacitors C_{LC} by applying a switching control signal Sc to the switch 500, thereby rapidly resetting the OCB liquid crystal. Due to this resetting, the optical transmittance of the liquid crystal becomes zero (black state).

Finally, in the B field of the frame, when a third scan signal S1(B) is applied to a first scan line S1 from the scan driver 200, pixels P11-P1m, which are connected to the first scan line S1, are selected. B data signals DB11-DB1m over data lines D1-Dm are provided from the source driver 300 to pixel electrodes as lower electrodes of liquid crystal capacitors C_{LC} of the pixels P11-P1m, which are connected to the first scan line S1. The common electrode Com is an upper electrode of the liquid crystal capacitor C_{LC} in the B field and is applied with a common voltage Vcom as a reference voltage. During this field of the frame, the blue backlight BLED emits a light source in the B field so that the OCB liquid crystal allows the blue light source to be transmitted with an optical transmittance corresponding to the data signals DB11-DB1m.

Before transitioning to the R field of the next frame from the B field of the frame, the timing controller 100 applies a high voltage output from the DC-DC converter 400 to the common electrode Com of the liquid crystal capacitors C_{LC} by applying a switching control signal Sc to the switch 500, thereby rapidly resetting the OCB liquid crystal. Due to this resetting, the optical transmittance of the liquid crystal becomes zero (black state).

Subsequently, when scan signals (S2(R), S2(G), and S2(B)) are sequentially applied to a second scan line S2 per each of the R, G, and B fields of the frame, as done in the above-described frame, R, G, and B data signals DR21-DR2m, DG21-DG2m, and DB21-DB2m are sequentially provided to pixel electrodes as lower electrodes of liquid crystal capacitors C_{LC} of pixels P21-P2m, which are connected to the second scan line S2. The common electrode Com is an upper electrode of the liquid crystal capacitor C_{LC} and is applied with a common voltage Vcom as a reference voltage in each of the R, G, and B fields. The RLED, the GLED, and the BLED sequentially output light sources during the respective R, G, and B field periods, so that the OCB liquid crystal of each of the pixels P21-P2m allows the red, green, and blue light sources to be sequentially transmitted with respective optical transmittances corresponding to the R, G, and B data signals DR21-DR2m, DG21-DG2m, and DB21-DB2m.

As in the first scan line S1, before each field in the second scan line S2, the timing controller 100 applies a high voltage output from the DC-DC converter 400 to the common electrode Com of the liquid crystal capacitor C_{LC} by applying a switching control signal Sc to the switch 500, thereby rapidly resetting the OCB liquid crystal, then the process proceeds to the next field.

When a scan signal is applied to the n^{th} scan line Sn per each of the R, G, and B fields of the frame by repeating the above-described operations, R, G, and B data signals DRn1-DRnm, DGn1-DGnm, and DBn1-DBnm are sequentially provided to pixel electrodes as lower electrodes of liquid crystal capacitors C_{LC} of pixels Pn1-Pnm, which are each connected to the n^{th} scan line Sn. The common electrode Com is an upper electrode of the liquid crystal capacitor C_{LC} and is applied with a common voltage Vcom as a reference voltage in each of the R, G, and B fields. The RLED, the GLED, and the BLED sequentially output light sources during the respective R, G, and B field periods, so that the OCB liquid crystal of each of the pixels Pn1-Pnm allows the red, green, and blue light sources to be sequentially transmitted with respective optical transmittances corresponding to the R, G, and B data signals DRn1-DRnm, DGn1-DGnm, and DBn1-DBnm.

As with the first scan line S1, before the transition to each field in the n^{th} scan line Sn of the frame, the timing controller 100 applies a high voltage output from the DC-DC converter 400 to the common electrode Com of the liquid crystal capacitor C_{LC} by applying a switching control signal Sc to the switch 500, thereby rapidly resetting the OCB liquid crystal, then the process proceeds to the next frame.

Accordingly, each frame is divided into three fields, i.e., R, G, and B fields, and R, G, and B data and backlights are sequentially driven in the three fields to display an image. Time taken to sequentially emit the R, G, and B backlights is short, so that the image is perceived as if the R, G, and B backlights simultaneously emit light, thereby displaying a normal image.

The field sequential LCD according to the second embodiment of the present invention applies a high voltage Vre output from the DC-DC converter 400 to the common electrode in each field to reset the OCB liquid crystal, thereby reducing a blurring effect such that a screen becomes blurred due to the current field being affected by data of the previous field. The field sequential LCD according to the second embodiment also prevents the brightness from deteriorating due to the black data insertion because the high voltage used to perform a bend transition on the OCB liquid crystal in the OCB mode is used as the reset voltage to shorten the reset time.

FIG. 9 is a timing diagram illustrating a method of driving an OCB mode LCD in accordance with a third embodiment of the present invention.

Referring to FIG. 9 and the LCD shown in FIG. 6, in the method of driving the LCD according to the third embodiment of the present invention, when scan signals are sequentially applied to scan lines S1-Sn from the scan driver 200, a plurality of pixels P11-Pnm connected to the scan lines S1-Sn are sequentially selected, and data signals D11, D12, and D13 are provided from the source driver 300 to pixel electrodes as lower electrodes of liquid crystal capacitors C_{LC} of the pixels P11-P1m, which are connected to the scan lines S1-Sn, respectively. In this case, a common electrode is an upper electrode of the liquid crystal capacitor C_{LC} and is applied with a common voltage Vcom as a reference voltage while the scan lines S1-Sn are driven. In addition, while the scan lines S1-Sn are driven, the backlight 800 emits light sources, which are transmitted through the OCB liquid crystal having a transmittance level corresponding to the data signals D11, D12, D13- . . . Dm thereby being displayed via red, green, and blue color filters.

In addition, referring to FIG. 9, before the data signals D11, D12, D13, . . . Dm are applied to each pixel, the timing controller 100 applies a high voltage Vre output from the DC-DC converter 400 to the common electrode Com of the liquid crystal capacitor C_{LC} by applying a switching control signal Sc to the switch 500 to rapidly reset the OCB liquid crystal. In this case, the optical transmittance of the liquid crystal becomes zero (black state). Here, reference “tre” means a reset time, which is quite short because a reset voltage of 15V to 30V is applied compared to the conventional reset voltage of 5V to 7V.

The color filter type LCD according to the third embodiment of the present invention applies a high voltage Vre output from the DC-DC converter 400 to the common electrode at an initial stage when data are input to each pixel to rapidly reset the OCB liquid crystal of each of the pixels P11-Pnm, thereby reducing a blurring effect that causes a screen to become blurred due to the previous data affecting it. This embodiment prevents the brightness from deteriorating due to the black data insertion because a high voltage is used to perform a bend transition on the liquid crystal in the OCB mode and is used as the reset voltage to shorten the reset time.

As mentioned above, the OCB mode LCD according to embodiments of the present invention applies a high voltage output from the DC-DC converter and is used to carry out a bend transition on the OCB liquid crystal in the OCB mode by application to the common electrode as a reset voltage to rapidly reset the OCB liquid crystal of each pixel, thereby removing the blurring effect that causes a screen to become blurred due to the current field being affected by the previous frame, the previous gray scale data, or the previous field when implementing moving pictures. The embodiments enhance the brightness by means of a shortened reset time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device (LCD), comprising:
a liquid crystal display panel having a plurality of pixels, each pixel being positioned at an intersection between a plurality of scan lines and a plurality of data lines and including a liquid crystal capacitor composed of a common electrode, a pixel electrode, and an optically compensated birefringence (OCB) liquid crystal;
a scan driver for applying a scan signal to the plurality of scan lines;
a source driver for applying gray scale data to the plurality of data lines;
a direct current to direct current (DC-DC) converter for generating an output voltage for carrying out a bend transition on the OCB liquid crystal;
a switch for selecting the output voltage of the DC-DC converter and a common voltage and transferring the voltages to the common electrode;
a light source controller for controlling a backlight for emitting light to the liquid crystal display panel; and
a timing controller for controlling operations of the scan driver, the source driver, the switch, and the light source controller,
wherein the switch applies the output voltage of the DC-DC converter to the common electrode before a start of each frame to reset the OCB liquid crystal.

2. The LCD of claim 1, wherein the output voltage of the DC-DC converter is 15V to 30V.

3. The LCD of claim 1, wherein the source driver does not apply the gray scale data when the switch selects the output voltage of the DC-DC converter.

4. The LCD of claim 1, wherein the OCB liquid crystal has an optical transmittance of zero when the OCB liquid crystal is reset.

5. The LCD of claim 1, wherein the backlight comprises a red LED, a green LED, and a blue LED which sequentially emit red, green, and blue light.

6. The LCD of claim 1, wherein the backlight comprises one of a white light emitting diode (LED) and a cold cathode fluorescence lamp (CCFL) which emits white light.

7. The LCD of claim 6, further comprising red, green, and blue color filters positioned on the common electrode of the plurality of pixels for filtering light emitted from the backlight.

8. The LCD of claim 1, wherein each pixel comprises:
a switching transistor for transferring the gray scale data transferred via the data lines to the pixel electrode in response to the scan signal on the scan lines; and
a storage capacitor for storing the gray scale data.

9. A liquid crystal display device (LCD), comprising:
a liquid crystal display panel having a plurality of pixels, each pixel being positioned at each intersection between a plurality of scan lines and a plurality of data lines and including a liquid crystal capacitor composed of a common electrode, a pixel electrode, and an optically compensated birefringence (OCB) liquid crystal;
a scan driver for applying a scan signal to the plurality of scan lines;
a source driver for sequentially applying red, green, blue gray scale data to the plurality of data lines;
a direct current to direct current (DC-DC) converter for outputting a DC voltage for carrying out a bend transition on the OCB liquid crystal;
a switch for selecting the output voltage of the DC-DC converter and a common voltage and transferring the voltages to the common electrode;
a light source controller for controlling red, green, and blue light emitting diodes to sequentially emit light to the liquid crystal display panel; and
a timing controller for controlling operations of the scan driver, the source driver, the switch, and the light source controller,
wherein one frame is divided into red, green, and blue fields and the switch applies the output voltage of the DC-DC converter to the common electrode before a start of each field to reset the OCB liquid crystal.

10. The LCD of claim 9, wherein the output voltage of the DC-DC converter is 15V to 30V.

11. The LCD of claim 9, wherein the source driver does not apply the red, green, and blue gray scale data when the switch selects the output voltage of the DC-DC converter.

12. The LCD of claim 9, wherein the OCB liquid crystal has an optical transmittance of zero when the OCB liquid crystal is reset.

13. The LCD of claim 9, wherein each pixel comprises:
a switching transistor for transferring the red, green, and blue gray scale data transferred via the data lines to the pixel electrode in response to the scan signal of the scan lines; and
a storage capacitor for storing the gray scale data.

14. A liquid crystal display device (LCD), comprising:
a liquid crystal display panel having a plurality of pixels, each pixel being positioned at each intersection between a plurality of scan lines and a plurality of data lines and including a liquid crystal capacitor composed of a common electrode, a pixel electrode, and an optically compensated birefringence (OCB) liquid crystal;
a scan driver for applying a scan signal to the plurality of scan lines;
a source driver for applying gray scale data to the plurality of data lines;
a direct current to direct current (DC-DC) converter for outputting a DC voltage for carrying out a bend transition on the OCB liquid crystal;
a switch for selecting the output voltage of the DC-DC converter and a common voltage and transferring the voltages to the common electrode;
a light source controller for controlling a backlight for emitting light to the liquid crystal display panel; and
a timing controller for controlling operations of the scan driver, the source driver, the switch, and the light source controller,
wherein the switch applies the output voltage of the DC-DC converter to the common electrode to reset the OCB liquid crystal before the gray scale data are applied to the plurality of pixels.

15. The LCD of claim 14, wherein the output voltage of the DC-DC converter is 15V to 30V.

16. The LCD of claim 14, wherein the source driver does not apply the gray scale data when the switch selects the output voltage of the DC-DC converter.

17. The LCD of claim 14, wherein the OCB liquid crystal has an optical transmittance of zero when the OCB liquid crystal is reset.

18. The LCD of claim 14, wherein the backlight comprises one of a white light emitting diode (LED) and a cold cathode fluorescence lamp (CCFL) which emits white light.

19. The LCD of claim 18, further comprising red, green, and blue color filters positioned on the common electrode of the plurality of pixels for filtering light emitted from the backlight.

20. The LCD of claim 14, wherein each pixel includes:
a switching transistor for transferring the gray scale data transferred via the data lines to the pixel electrode in response to the scan signal of the scan lines; and
a storage capacitor for storing the gray scale data.

21. A method of driving a liquid crystal display device (LCD) including a plurality of pixels having an optically compensated birefringence (OCB) liquid crystal positioned between a common electrode to which a common voltage is applied and a pixel electrode to which gray scale data are applied, a direct current to direct current (DC-DC) converter outputting a voltage for carrying out a bend transition on the OCB liquid crystal at a fast speed, and a backlight outputting light to the plurality of pixels, the method comprising:
(a) applying a voltage to the OCB liquid crystal from the DC-DC converter to carry out the bend transition on the OCB liquid crystal at an initial start of the LCD;
(b) applying the gray scale data of a frame to the pixel electrode in the frame;
(c) applying a voltage to the common electrode from the DC-DC converter to reset the OCB liquid crystal after the step (b);
(d) applying the gray scale data of a second frame to the pixel electrode in the second frame; and
(e) repeating the steps (b) to (d).

22. The method of claim 21, wherein the output voltage of the DC-DC converter is 15V to 30V.

23. The method of claim 21, wherein the gray scale data are not applied in the step (c).

24. The method of claim 21, wherein the OCB liquid crystal has an optical transmittance of zero when the OCB liquid crystal is reset.

25. The method of claim 21, wherein the backlight emits light during the steps (b) to (d).

26. The method of claim 21, wherein the backlight comprises a red light emitting diode (LED), a green LED, and a blue LED which sequentially emit red, green, and blue light.

27. The method of claim 21, wherein the backlight comprises one of a white light emitting diode (LED) and a cold cathode fluorescence lamp (CCFL) which emits white light.

28. The method of claim 27, further comprising red, green, and blue color filters positioned on the common electrode of the plurality of pixels and filtering light emitted from the backlight.

29. A method of driving a liquid crystal display device (LCD) including a plurality of pixels having an optically compensated birefringence (OCB) liquid crystal positioned between a common electrode to which a common voltage is applied and a pixel electrode to which red, green, and blue gray scale data are sequentially applied, a direct current to direct current (DC-DC) converter outputting a voltage for carrying out a bend transition on the OCB liquid crystal at a fast speed, and a backlight having red, green, and blue light sequentially transmitted to each of the pixels, the method comprising:
(a) applying a voltage to the OCB liquid crystal from the DC-DC converter to carry out the bend transition on the OCB liquid crystal at an initial start of the LCD;
(b) dividing one frame into red, green, and blue fields, and applying the red gray scale data to the pixel electrode in the red field;
(c) applying a voltage to the common electrode from the DC-DC converter to reset the OCB liquid crystal after the step (b);
(d) applying the green gray scale data to the pixel electrode in the green field;
(e) applying a voltage to the common electrode from the DC-DC converter to reset the OCB liquid crystal after the step (d);
(f) applying the blue gray scale data to the pixel electrode in the blue field;
(g) applying a voltage to the common electrode from the DC-DC converter to reset the OCB liquid crystal after the step (f); and
(h) repeating the steps (b) to (g).

30. The method of claim 29, wherein the output voltage of the DC-DC converter is 15V to 30V.

31. The method of claim 29, wherein the red, green, and blue gray scale data are not applied in the steps (c), (e), and (f).

32. The method of claim 29, wherein the OCB liquid crystal has an optical transmittance of zero when the OCB liquid crystal is reset.

33. The method of claim 29, wherein the backlight emits light during the steps (b) to (h).

34. The method of claim 29, wherein the backlight comprises a red light emitting diode (LED), a green LED, and a blue LED which sequentially emit red, green, and blue light.

35. A method of driving a liquid crystal display device (LCD) including a plurality of pixels having an optically compensated birefringence (OCB) liquid crystal positioned between a common electrode to which a common voltage is applied and a pixel electrode to which gray scale data are applied, a direct current to direct current (DC-DC) converter outputting a voltage for carrying out a bend transition on the OCB liquid crystal at a fast speed, and a backlight outputting light to the plurality of pixels, the method comprising:
(a) applying a voltage to the OCB liquid crystal from the DC-DC converter to carry out a bend transition on the OCB liquid crystal at an initial start of the LCD;
(b) applying (n−1)^{th} gray scale data to a pixel electrode of an (n−1)^{th} pixel among the plurality of pixels;
(c) applying a voltage to the common electrode from the DC-DC converter to reset the OCB liquid crystal after the step (b);
(d) applying n^{th} gray scale data to a pixel electrode of an n^{th} pixel;
(e) applying a voltage to the common electrode from the DC-DC converter to reset the OCB liquid crystal after the step (d); and
(f) repeating the steps (b) to (e).

36. The method of claim 35, wherein the output voltage of the DC-DC converter is 15V to 30V.

37. The method of claim 35, wherein the gray scale data are not applied in the steps (c) and (e).

38. The method of claim 35, wherein the OCB liquid crystal has an optical transmittance of zero when the OCB liquid crystal is reset.

39. The method of claim 35, wherein the backlight emits light during the steps (b) to (f).

40. The method of claim 35, wherein the backlight is composed of a white light emitting diode (LED) or a cold cathode fluorescence lamp (CCFL) which emits white light.

41. The method of claim 40, further comprising red, green, and blue color filters positioned on the common electrode of the plurality of pixels and filtering light emitted from the backlight.
